(19) United States
(12) Patent Application Publication
(10) Pub. No.: US 2013/0151298 A1
(43) Pub. Date: Jun. 13, 2013

(54) ACQUIRING AND DISTRIBUTING TASKS

(71) Applicant: Moose Loop Holdings, LLC, Salt Lake City, UT (US)

(72) Inventor: Ken R. Davis, Salt Lake City, UT (US)

(73) Assignee: Moose Loop Holdings, LLC, Salt Lake City, UT (US)

(21) Appl. No.: 13/688,081

(22) Filed: Nov. 28, 2012

Related U.S. Application Data
(60) Provisional application No. 61/569,599, filed on Dec. 12, 2011.

(51) Int. Cl. G06Q 10/06

(52) U.S. Cl. CPC G06Q 10/06311
USPC 705/7.14; 705/7.13

(57) ABSTRACT

Technology is described for acquiring a task and distributing the task to a service provider. The technology may include obtaining a task purchase from a customer and assigning the task to a service provider using a statistical method that considers weightings placed upon a task and weightings placed upon a plurality of service providers. Alternatively, a service provider may purchase a task at a fixed price. A fixed price may be determined by calculating a task acquisition cost using an average customer conversion cost.

### PRIORITY CLAIM

Priority is claimed to U.S. Provisional Patent Application Ser. No. 61/569,599 filed Dec. 12, 2011, which is hereby incorporated herein by reference in its entirety.

### BACKGROUND

Many goods may be purchased in a commoditized way. A consumer can have certain criteria when deciding to purchase goods, and if the goods meet the desired criteria, then the consumer generally does not care who provides the goods.

Services have traditionally been less commoditized. Rather, services are typically purchased after comparing service providers to one another. For example, service providers may be compared through a bidding process, interviews, and/or online user feedback ratings. Such service provider comparisons may be challenging for a consumer to interpret due the non-uniformity in services supplied by various service providers. This has resulted in uncertainty to the consumer as to the comparative cost of services, reliability of services, and the quality of services provided by service providers.

### BRIEF DESCRIPTION OF THE DRAWINGS

FIG. 1 is a block diagram illustrating an example system for distributing and/or acquiring a task.

FIGS. 2a-2c are drawings that depict examples of an interface illustrating elements of weighting a task and weighting a service provider.

FIG. 3 illustrates an example of distributing tasks to service providers.

FIG. 4 is a flowchart illustrating an example method for distributing a plurality of tasks among a plurality of service providers.

FIG. 5 is a flowchart illustrating an example method for a service provider to acquire a task at a fixed price.

FIG. 6 is a drawing that depicts example interfaces for a service provider to acquire a task at a fixed price.

FIG. 7 is block diagram illustrating an example of a computing device that may be used for distributing and/or acquiring a task.

### DETAILED DESCRIPTION

A technology is described for obtaining a requested task or purchased task from a customer and distributing the task to a service provider selected from a pool of service providers. In addition, a process may be provided for a service provider to acquire a task at a fixed price. Service providers may include vendors, contractors, or any person or entity that may perform a service to a customer. Customers that purchase a service via a task broker may do so without much deference as to who performs the service. Rather, a customer's concern may be that the service is performed by a service provider according to certain criteria. For example, a customer may purchase a lawn mowing task via a task broker. The customer may not care who actually performs the lawn mowing service, as long as the service is performed according to the criteria that the customer requested. In a commoditized services market, a challenge may be how to fairly distribute services to a number of service providers while ensuring that the customer's expectations are met.

Commoditized services may also be sold to a service provider. For example, a marketer may advertise to a customer a lawn mowing service at a fixed price. The customer may purchase the lawn mowing service from the marketer, and the marketer may then sell the lawn mowing task to a service provider whose trade is to mow lawns. A challenge that the marketer may face in selling a task to a service provider is how to recoup advertising costs expended in order to convert an advertising prospect into a customer.

More accurate and efficient access to services may be used to commoditize services not traditionally commoditized in the past by allowing the services to be priced and delivered in a more uniform fashion. Such access to services can be provided by operations implemented in networking and computing hardware. For example, a market may be generated where customers may purchase services or tasks from an electronic source, and the operations may either distribute those tasks to a pool of service providers using statistical methods or the tasks may be made available to a pool of service providers to purchase a task at a price that may be proportionate with the advertising costs expended to acquire the task.

A method that includes task weighting and service provider weighting may be utilized to determine how a task may be distributed or assigned to service providers. Task weightings may be based on various criteria such as the type of task, task valuation, location, etc. For example, a first task may have a higher value as compared to a second task. As an example, a large lawn may have a higher price ($100) due to the size of the lawn and the lawn may be mowed once a week. Whereas, a small lawn ($30) may be mowed just once a month. Thus, an example of relative value may be that the large lawn may receive a greater weighting as a task and the small lawn may receive a lesser weighting. In a related example, if the small lawn ($30) is being mowed each week ($30×4=$120) and if the large lawn ($100) is being mowed once a month, then the weight assigned to the small lawn may be greater and the weight assigned to the large lawn may be lesser (i.e., less than the small lawn). Service provider weightings may also be based on various criteria. For example, a first service provider may be a certified plumber and a second service provider may be a general handyman. The first service provider, the certified plumber, may receive a greater weighting based upon the service provider's certification and the second service provider, the general handyman, may receive a lesser weighting because of the service providers lack of certification. Weighting tasks and service providers may provide for a distribution method that may be more equitable in assigning tasks to service providers.

A method for offering a task to a service provider at a fixed price may have the effect of benefiting the parties that are privy to a fixed price transaction. For example, customers may receive better service from a service provider because the service provider may feel vested in the task and as a result may provide a higher quality of service in the expectation of recouping the fixed price. A marketing entity or advertiser may benefit by recouping costs associated with converting online visitors into customers, and service providers may benefit by saving on marketing costs that may be associated with obtaining new customers and tasks.

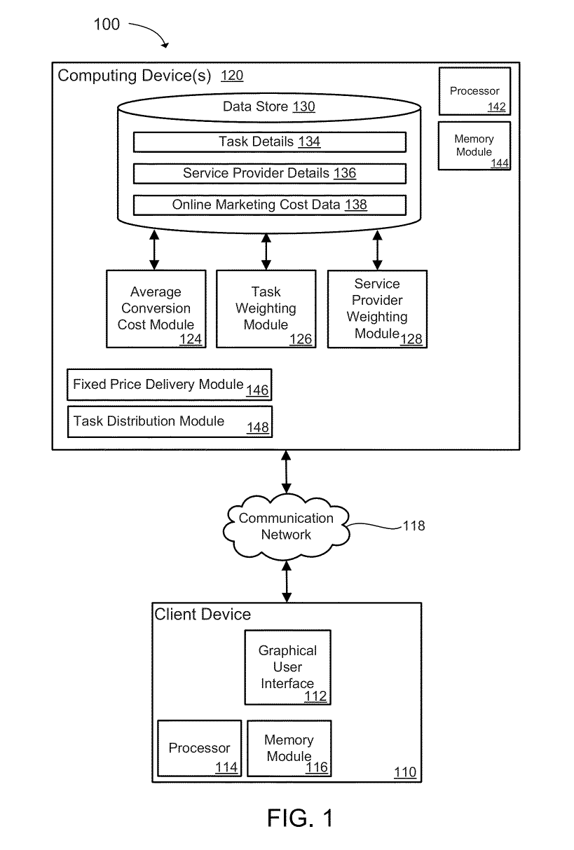

As illustrated in FIG. 1, a system may be used for receiving a requested or purchased task from a customer and distributing the task to a service provider and/or making the task available at a fixed price to a service provider. The system may include a client device 110 through which a user (e.g., service provider or customer) can access information related to tasks and customers over a communications network 118. The communications network can be a local area network (LAN), wide area network (WAN), or the internet. A graphical user interface 112 can be provided to the user using the client device 110 to access the task, customer, and related information located on a separate computing device 120. A client device 110 with a graphical user interface 112 may be used by either a service provider or a customer.

Parameters for a task that the customer desires to be performed can be received by the graphical user interface 112 of the client device 110. For example, the customer may type, speak, write, or select task parameters that the client device 110 can capture. Payment for the task selected by the customer may also be supplied via the graphical user interface. In one example, payment via a credit card or debit transaction may be collected before the task may be assigned to a service provider for performance. The client device may include a processor 114 and a memory module 116. A client device 110 may be a device such as, for example, a desktop computer, a laptop, a tablet, a mobile device, a television, a cell phone, a smart phone, a hand held messaging device, a set-top box, a gaming console, a personal data assistant, an electronic book reader, heads up display (HUD) glasses, or any device with a display that may present the graphical user interface 112.

The parameters for a task collected by the client device 110 can be sent to a computing device 120. The computing device 120 may be provided with modules for distributing a plurality of tasks to a pool of service providers and making plurality of tasks available to purchase at a fixed price to a pool of service providers. The computing device 120 may be a single server, a distributed server environment, a server farm, or any computing device or group of computing devices that may service requests from other computing devices or programs. In addition, the computing device may include one or more processors 142 and memory modules 144.

Various processes and/or other functionality may be executed in the computing environment 100 according to various embodiments. Also, various data may be stored in a data store 130 that may be accessible to the computing device 100. The term “data store” may refer to any device or combination of devices capable of storing, accessing, organizing and/or retrieving data, which may include any combination and number of data servers, relational databases, object oriented databases, cloud storage systems, data storage devices, data warehouses, flat files and data storage configuration in any centralized, distributed, or clustered environment. The storage system components of the data store 130 may include storage systems such as a SAN (Storage Area Network), cloud storage network, volatile or non-volatile RAM, optical media, or hard-drive type media. The data store 130 may be representative of a plurality of data stores 130.

The data stored in the data store 130 may include, for example, task details 134, service provider details 136 and online marketing cost data 138. Details relating to a task may be stored in the data store. Task details 134 may include, among other things: the task type, market, location, scheduled start time, estimated task time, customer instructions and any other detail that may be related to a task. Similarly, service provider details 136 may include any information that may be associated with a service provider, for example, address, trade, skills, training, quality ratings, headquarters location, current location, available time slots, previous tasks distributed to the service provider, etc. Historical online marketing cost data 138 may be gathered to help determine how much money a marketing company may expend in marketing costs in order to convert an online visitor (e.g., marketing recipient) into a customer that orders tasks.

A task purchased or requested by a customer may be distributed to a service provider by a task distribution module 148. The task distribution module 148 may distribute a task based upon a statistical method that may consider weighting placed upon a task and a weighting placed upon a pool of service providers. Weighting placed upon a task may be accomplished using a task weighting module 126. The task weighting module 126 may consider a number of factors when assigning a weight to a task, among these may be the task type (e.g., lawn mowing, window washing), task price, reoccurrence of the task, task market location, the level of service desired, etc. For example, a basic lawn mowing task may call for a service provider to cut the grass, whereas a premium lawn mowing task may call for the service provider to 1) cut the grass, 2) trim the edges and 3) blow loose grass off sidewalks. Because the premium lawn mowing task includes additional services, the value of the task may be increased and the service provider may realize a greater profit on the premium lawn mowing task as opposed to the basic lawn mowing task. The task weighting module 126 may assign a greater weight to a premium task because of the task's increased value to a service provider or within the task assignment system.

Another example of applying a weighting to a task may be where the task may be a recurring task. A task that may be performed one time, such as repairing a fence may be assigned a lower weight as compared to a task that may be performed over and over again, such as cleaning a swimming pool. The greater weight may be applied to the pool cleaning task because over the period of a summer, the pool may need to be cleaned once a week at $50 per week and the task may gross $600 over twelve weeks. Whereas the fence repair task may gross $100. A task that may be recurring may have the potential to earn higher profits for the service provider and therefore may be assigned a greater weight compared to a non-recurring task.

Weightings assigned to service providers may be accomplished by the service provider weighting module 128. Like tasks, service providers may also be assigned a weighting based upon factors such as the quality of the service provider's workmanship, the task's proximity to the service provider's headquarters, proximity to other tasks that the service providers may be working on, proximity to the service provider's current global positioning system (GPS) coordinates, as well as a number of other factors. Any weight value may be assigned to a service provider. A low value (e.g., zero) may indicate that a service provider may be unable to perform the task or may be unqualified to perform the task. A high value (e.g., greater than zero) may indicate that a service provider may be well qualified and may be assigned the task. In one example where a task may be for an electrical repair, a service provider who practices the trade of an electrician may receive a greater weighting than a service provider whose trade may be to mow lawns. In the alternative, where a task is to mow a lawn, a service provider having a trade of lawn mowing may receive a greater weight than a service provider who may be an electrician.

In addition to distributing a task to a service provider, the fixed price delivery module 146 may provide a task to a service provider at a fixed price. The fixed price of the task may reflect the cost associated with marketing to a potential customer. The average conversion cost module 124 may calculate an average monetary amount expended to convert an online advertising prospect into a customer. This may be accomplished by obtaining historical online marketing cost data 136 from the data store 130. For example, a system may track the marketing efforts of a marketing company, marketing project or marketing campaign that places banner advertising on pages returned by internet search engines. When a user executes an internet search that may be associated with a task that the service company offers, an advertisement may be included with the search results. When a user clicks on the banner advertisement, the user may be taken to the service company page where the user may order a task. A system may track the number of users that clicked on the banner advertisement and store that information in a data store. The system may also track how many of those users ended up ordering a task. This data may then be obtained from the online marketing cost data 136 and used by the average conversion cost module 124 to calculate how much a company spent on average per customer for online advertising. Or in other words, how much a company spent on advertising to convert one online visitor into a customer that orders a task. This information then may be used by the fixed price delivery module 146 to set a price for a task that reflects the cost expended by the company to acquire a task, and that task may be made available to a service provider to purchase. This same process described above may also be applied to marketing campaigns that use mailers, television, radio or other marketing channels. One example benefit of the described process may be that the cost of advertising may be normalized nationally allowing service providers to acquire a task at a fixed and predictable cost. For example, advertising costs in a large metropolitan city may be substantially different than advertising costs in a small rural city. The process may normalize the cost of advertising between the two cities by allowing a service provider to expend resources to directly acquire customers or tasks using the system rather than expending resources on advertising to acquire new customers. Tasks that a service provider may acquire using the system may be prepaid by the customer, allowing for resources expended by a service provider to be spent on a guaranteed task rather than a task lead.

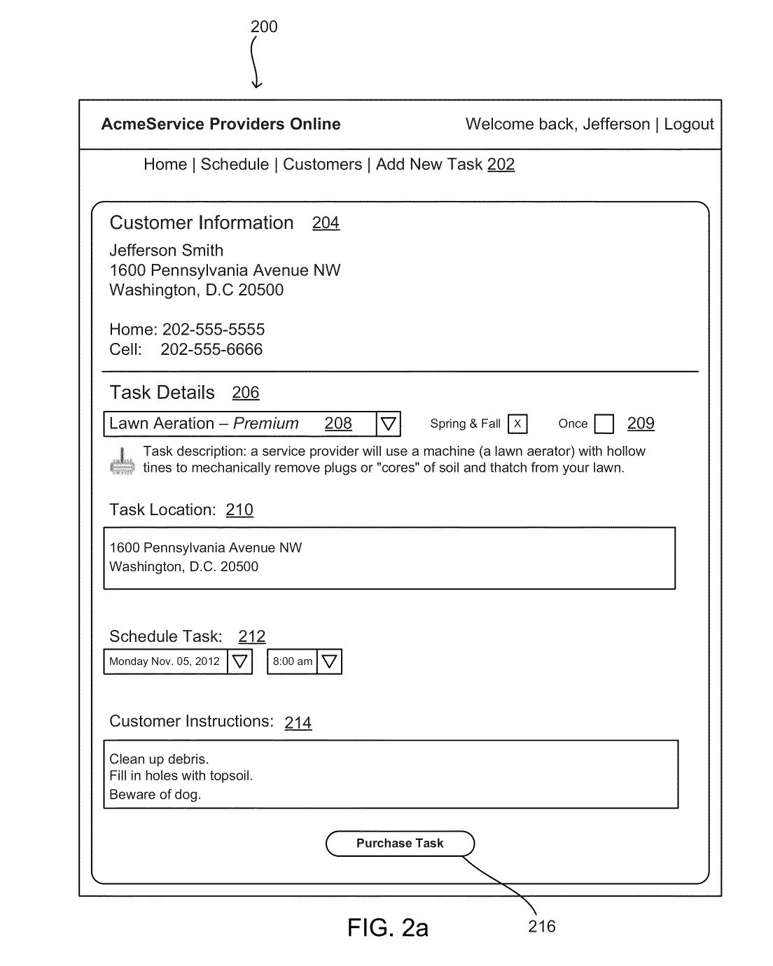

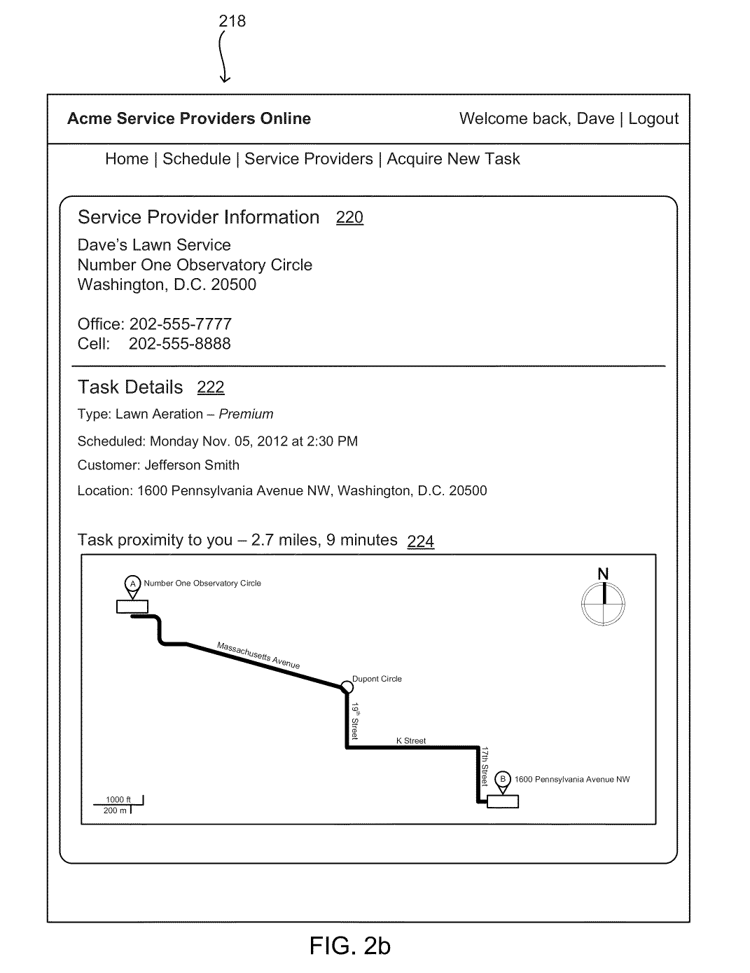

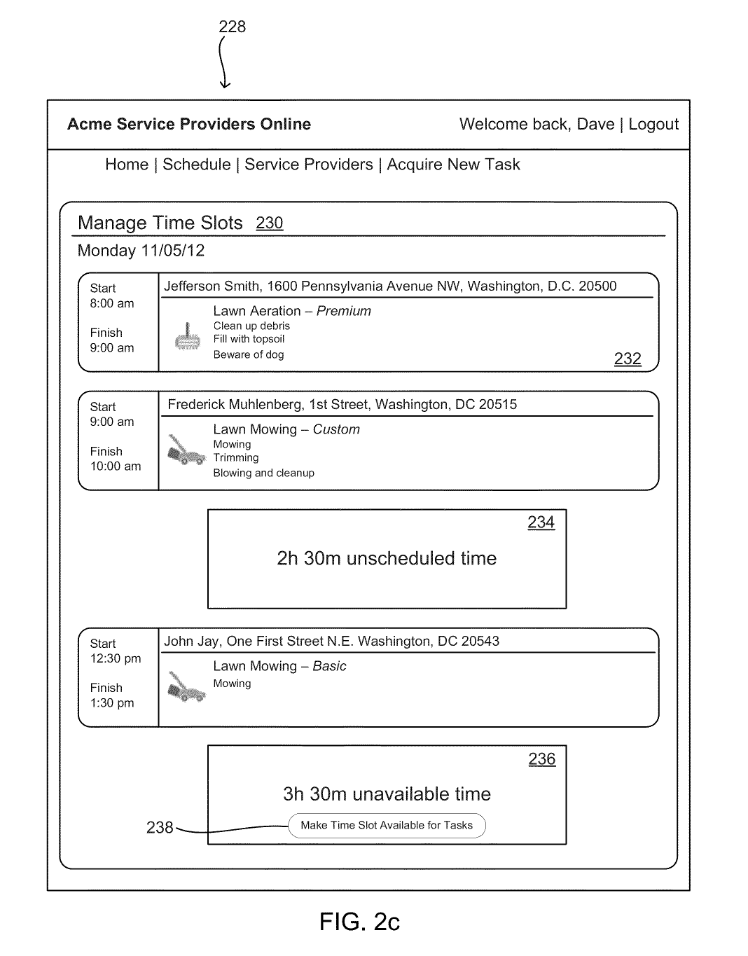

Moving now to FIG. 2a, an example page 200 is illustrated as may be rendered by a client device. A task may be obtained from a customer through an electronic interface. The electronic interface may be presented to a customer in the form of an interactive page as depicted in FIG. 2a. A customer may login to a customer account or a new customer may setup a new customer account and the page may show the customer's information 204. The page 200 may provide a menu allowing the customer to add a new task 202. The customer then may provide task details 206 for the task that the customer wishes to purchase. Task details may include a task type 208 that a service provider may perform. For example, the task type 208 illustrated in FIG. 2a is premium lawn aeration. But a task type may be lawn mowing, window washing, pool cleaning, pest control, or any task that a service provider may perform.

A customer may also provide a task location 210. The task location 210 may be at the address associated with the customer's information 204 or may be the customer's residence, work location or any other location that the customer specifies. The task location 210 may be located within a desirable market and therefore a greater weight may be assigned to the task. For example, where a task location 210 is located in a high income portion of a city, the price paid by a customer for the task may be more than that of a task that may be located in a low income portion of a city and thus the task may be of more value to a service provider. In addition, a service provider may need to pay for parking and additional road tolls to get into a city center, which may also increase a price paid by customers in certain places.

A date and time may be entered by the customer to schedule the task 212. In addition, a customer may provide a plurality of dates and/or times or ranges allowing flexibility in scheduling the task. Customer instructions 214 may also be included in the task details 206 allowing a customer to communicate directions to a service provider or to make a service provider aware of circumstances that may affect performance of the task. After a customer has provided all the task details 206 that may be necessary to perform the task, the customer then may purchase the task, as in this example, by selecting a button 216.

A task obtained from a customer may be weighted so that the task may be fairly distributed to a service provider among a pool of service providers. Weighting a task may be done based upon the task details 206. For example FIG. 2a shows task details 206 that include a task type 208 of premium lawn aeration. Because the task type 208 may be for premium lawn aeration, the task may be assigned a greater weight than basic lawn aeration. The difference in the two tasks may be that basic lawn aeration may involve using a machine to remove plugs of soil from a customer's lawn, whereas premium lawn aeration may include what the basic version offers, but in addition offers cleanup of the plugs of soil and filling in any plug holes with topsoil. Because the premium version offers additional services, the task may be priced higher than the basic version and a service provider may make more money performing the task. Thus, the premium lawn aeration warrants a higher weighting than that of the basic lawn aeration because the premium lawn aeration task may have a higher value to the service provider.

In another example, the system may track tasks and associated task weights that may be assigned to service providers. Tracking task assignments may allow the system to provide tasks to service providers in a fair manner, and/or allow service providers to purchase a more desirable task. For example, a service provider that may be provided with a task with a low weight may be entitled to a higher weighted task in a next round of task distributions. Alternatively, a service provider that may be provided a task with a low weight may purchase a higher weighted task rather than accept the lower weighted task. To illustrate, a basic task may be weighted lower than a premium task. A service provider that is provided with a basic task may accept the task with the expectation that the next task provided to the service provider may be a premium task, or the service provider may opt to pay an amount of money to obtain a premium task. In another illustration, a first service provider may receive a task during a round of task distributions whereas a second service provider may not receive a task. Because the second service provider did not receive a task, the second service provider may be assigned a greater weight. The system may track that the second service provider has a greater weight so that during the next round of task distributions the second service provider may have a greater possibility of being assigned a task.

A first task that may be a recurring task may have a higher value compared to a second task that may be a non-recurring task, and the recurring task may be assigned a greater weight. For example, where a task type 208 may be for premium lawn aeration and may be a recurring 209 task, the task may receive a greater weight than another task having a task type that is also premium lawn aeration, but may be a one time task. This weighting may be because a one time task may gross a service provider a one time payment, but a recurring task may gross a service provider a recurring payment over an extended time period.

Tasks may be weighted based upon a task's value. In one example, the value of a task may be determined by the task details 206. For instance, task details may include the time duration used to complete a task, thus customers may be charged more for tasks that take a long time to complete, and as a result the task may have a higher value compared to tasks that take a short time to complete. In another example, a task's value may be determined by the amount charged to a customer to complete the task. Tasks that may cost a customer more may be valued higher and receive a greater weight as compared to tasks that may cost a customer less.

In addition to weighting a task, service providers available to perform the task may be weighted based upon service provider criteria. Example criteria may include the service provider's trade, the number of time slots the service provider has available, the number of tasks a service provider has been assigned compared to other service providers and any other criteria that may be used in assigning a weight to a service provider. FIG. 2b is an example illustrating a page 218 that may be rendered by a client device. When a service provider logs in to the page 218, the service provider's information 220 may be presented to the service provider. Also, task details 222 may be presented to the service provider for a task that may have been either assigned to the service provider or acquired by the service provider. A criterion that may be used in assigning a weight to a service provider may be the proximity of a service provider to a task location. For example, the page 218 shows the service provider's proximity 224 to a task. The service provider's proximity to a task may be computed using one of many different locations, but may include the distance from the service provider's headquarters address to the task, the proximity of other tasks that are being performed by the service provider to the task, or the proximity of the service provider's current location to the task. A first service provider that has a closer proximity to a task location may be assigned a greater weight than a second service provider that may be farther away from the task location.

Service providers may designate time slots to a scheduling system that may organize a service provider's task appointments. FIG. 2c is yet another example of a page 228 that illustrates a service provider's daily task schedule as automatically scheduled. In this example schedule system, a service provider may manage time slots 230 that the service provider has made available to the scheduling system. Time slots may be filled with a task 232 that may have been assigned to the service provider or may be a task that has been acquired by the service provider. A greater weight may be assigned to a service provider that makes more of a service provider's time slots available to a scheduling system. For example, a service provider may have a block of time 236 available on a day where the service provider may be free to perform tasks. The service provider may make the time slot 238 available to the scheduling system and the system may assign the service provider one or more tasks to perform between these times. In another example, where a typical work week may comprise of forty hours, a first service provider may make 40% the service provider's available work hours available to a scheduling system, and a second service provider may make 75% of the service providers available work hours available to a scheduling system. The second service provider may be assigned a greater weighting than the first service provider because the second service provider made more of the service providers work hours available to the system and therefore may be available to perform more tasks.

In addition, a greater weight may be assigned to a service provider with a plurality of time slots that the service provider made available to a scheduling system that are left unassigned. For example, a service provider may have made a time slot 234 available between the times of 10:00 AM to 12:30 PM to a scheduling system, but the system may not have any tasks available to assign to the service provider between these times. Because the time slot was left unassigned by the system, the service provider may be given a preference by assigning a greater weight to the service provider, thus giving the service provider a better chance of obtaining a future task.

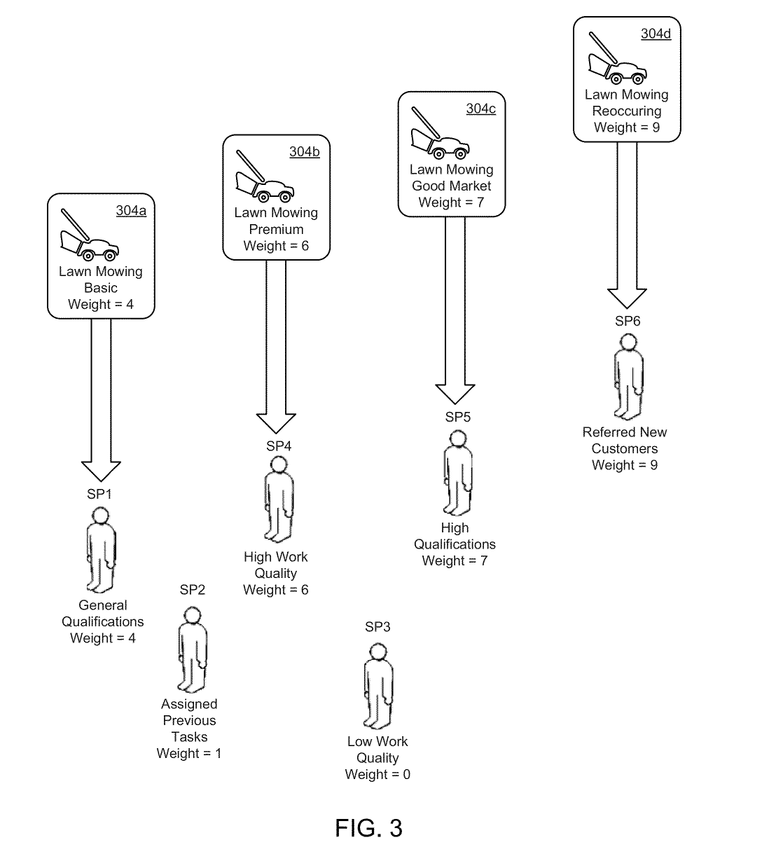

FIG. 3 illustrates a visual representation of weighted tasks that may be distributed to weighted service providers. A service provider may be weighted based upon the service provider's qualifications. For instance, a service provider may possess qualifications in one area (e.g., lawn mowing), but not in another (e.g., sprinkler repair). Further, a first service provider may be highly qualified (e.g., certified landscape technician) to perform a certain kind of task, whereas a second service provider (e.g., day laborer) may possess general qualifications to perform the same kind of task. For example, a task 304a for lawn mowing may be assigned to a service provider SP1. The lawn mowing task 304a may be considered a basic service, which may mean that the task 304a involves cutting the customer's grass without any additional services performed. Because the task 304a may be a basic service, the task may be assigned a relatively lesser weight of four. The service provider SP1 that the task 304a may be assigned to may also have a weight of four. This may be because the service provider SP1 possesses just general qualifications and thus warrants a lesser weighting as compared to another service provider that may possess higher qualifications. In another example, a task 304c may receive a relatively greater weight of seven because the task may be located in a good or desirable market. The task 304c may be assigned to a service provider SP5 that has been assigned a relatively greater weight of seven because the service provider SP5 has high qualifications. Customers within a desirable market that the task 304c may be located within may demand service providers that possess high qualifications and therefore the task 304c may be assigned to the service provider SP5 with high qualifications. The absolute weight value assigned to a task or a service provider may be immaterial except that the weight represents a greater or lesser weight in comparison to other tasks or service providers based upon the criteria employed. Also, in the current example, for tasks that may be assigned to service providers, the task weight and the service provider weight may be equivalent (i.e., 304a is assigned to SP1 and both have a weight of 4), but it will be appreciated that weights need not be equivalent and any statistical method may be used to assign a task to a service provider.

Service providers that have been assigned a greater number of tasks as compared to other service providers may be assigned a lesser weight. This may help with load balancing of the assigned tasks. As an example, a first service provider SP2 may have received one or more tasks in previous rounds of task distributions, whereas a second service provider SP9 may have not received a task in the previous task distributions. The first service provider may be assigned a lesser weight for a subsequent round of distribution as compared to the second service provider. The lesser weighting of the first service provider may provide the second service provider with a better chance of being assigned a task in the future and may help to promote fairness in the task distribution process.

The level of work quality that a service provider delivers may be used in assigning a weight to a service provider. Customers may rate service providers based upon the work quality provided by a service provider, and/or a customer may request that an inspector rate the work quality provided by a service provider. For example, in a case where a service provider SP3 delivers low work quality on a task, the service provider SP3 may be assigned a lesser weighting as compared to a service provider SP4 that delivers high work quality. Work quality may include many aspects related to a task, for instance where a task 304b involves mowing a lawn that may be a premium service, work quality may relate to whether the lawn was cut uniformly, the edges where trimmed and contoured and the grass clippings where gathered and disposed of completely. A service provider SP3 that fails to perform these components may be considered to have low work quality. For example, a service provider SP4 that accomplishes these components may be considered to have high work quality and may be assigned a greater weighting that may result in the distribution of a task 304b to the service provider.

In one example, a greater weight may be assigned to a service provider that has contributed multiple new customers by uploading the service provider's contacts into the system. For instance, when a new service provider may be added to a task system, the service provider may have an established customer base that the service provider may upload into the system. Also, an existing service provider may in the course of business obtain customer referrals or obtain new customers that the service provider may refer to the system. As an example, a service provider SP6 may be assigned a relatively greater weight of nine because the service provider SP6 referred new customers to the system. Due to the greater weight assigned, the service provider then SP6 may be given a task 304d that has been assigned a relatively greater weight of nine because the task 304d, as described earlier may be a recurring task.

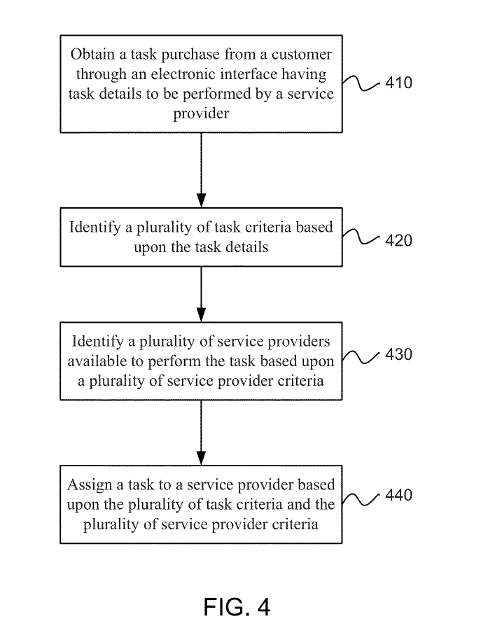

FIG. 4 is a flowchart illustrating an example method to distribute a plurality of tasks among a plurality of service providers. As in block 410, a task purchase may be obtained from a customer through an electronic interface. The task purchased by the customer may have task details that may be performed by a service provider. For example, a customer may purchase a task using an electronic device that may be capable of rendering an electronic interface, such as a desktop computer, laptop, tablet computer, smartphone or any other such device. A task may include but is not limited to a commoditized service. Examples of a task may include landscaping, pool cleaning, locksmith services, tenant eviction, house painting, house cleaning, building construction, as well as a number of additional tasks that may be purchased through an electronic interface running on an electronic device. The purchased task may have task details that may include the task type, location, price, schedule, customer instructions, etc.

As in block 420, after a task has been obtained from a customer, task criteria may be identified that may be based upon the task details. Recurrence of a task may be an example of a task criterion. For instance many tasks, such as a task to paint a house, may involve a one time service. Whereas a task to clean a house may reoccur on a weekly or monthly basis. Other examples may include a task that has a task type of rekeying an entry door, where a task criterion may call for locksmith services. And in another example, a task that may have a task type of tree removal, wherein the task criteria may call for a chainsaw and a stump grinder. As a final example, a task may have a task detail that establishes a criterion that the task be performed on a specified day and time.

As in block 430, a plurality of service providers available to perform the task may be identified based upon a plurality of service provider criteria. Examples of service provider criteria may include the availability of a service provider to perform the task, the qualifications that a service provider possesses, the necessary equipment that the service provider has access to, the proximity of the service provider to the task location, feedback from customers about the quality of service that a service provider delivers, as well as any other criteria that may be relevant in identifying a service provider to perform the task.

As in block 440, after the task criteria and plurality of service providers have been identified, a task may be assigned to a service provider based upon the plurality of task criteria and the plurality of service provider criteria. In an example involving a task to replace a water heater, task criteria may call for: 1) a service provider that may be certified in water heater replacement, 2) that the task is desired to be performed as soon as possible and 3) specialized tools may be needed to perform the task correctly. The task then may be assigned to a service provider meeting service provider criteria. Thus the service provider may be 1) a certified water heater installer, 2) be within the proximity of the task allowing the service provider to respond and perform the task quickly and 3) own the specialized tools necessary to perform the task. As will be appreciated, this may be but one example of assigning a task having task criteria to a service provider having service provider criteria. Any combination of task criteria and service provider criteria may be used in assigning a task to a service provider.

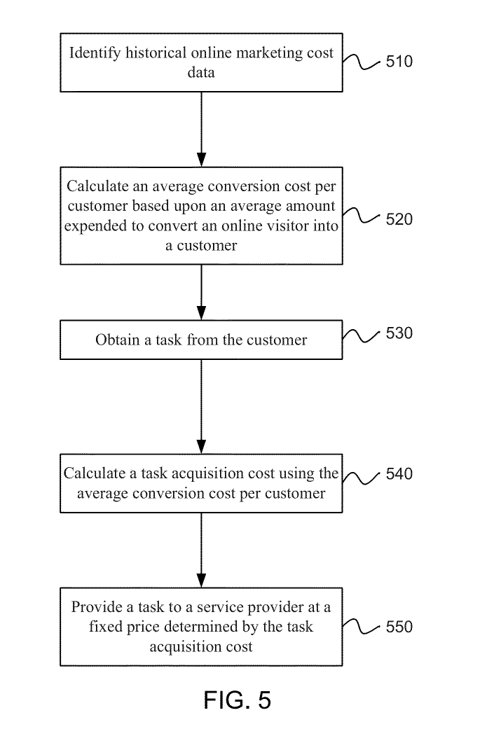

FIG. 5 is a flowchart illustrating an example method for a service provider to acquire a task at a fixed price. Significant resources may be expended on marketing in order to attract visitors to an electronic page with an objective to convert a visitor into a customer that purchases tasks. To recoup marketing costs, tasks may be offered to a service provider at a fixed price. As in block 510, historical online marketing cost data may be identified so that the data may be used by subsequent processes in calculating a fixed price task. Marketing data may be tracked and stored over time. Where insufficient data exists in a market to calculate a fixed price task, a similar market for online marketing may be identified and the historical online marketing cost data of the similar market may be used as a market proxy. For example, as a business expands into new markets, such as from Town A to a neighboring Town B, historical online marketing cost data may not exist for the new market of Town B. To overcome the lack of historical data, Town A may be used as a substitute for Town B due to the close proximity of the towns and the similarity of the town's residents. Thus Town A's historical online marketing cost data may be identified to use in determining a fixed price task for Town B.

The historical online marketing cost data identified in the previous process may be used to calculate, as in block 520, an average conversion cost per customer based upon an average amount expended to convert an online visitor into a customer. In one example, a cost per click (CPC) ad campaign model may have been used to attract visitors to a marketing page. Under the CPC model, a marketing entity may be charged a fee each time a visitor clicks on the marketer's listing and may then be directed to a page of the marketer's choice, often the appropriate task purchase page. When delivered to the task purchase page, the visitor then may become a customer by purchasing a task. Dividing the total cost of the CPC ad campaign by the number of customer conversions (task purchasing visitors) that resulted from the CPC ad campaign, an average cost may be calculated that represents a customer conversion cost. Other examples of ad campaign models may include a cost per visitor model, where a marketer pays for the delivery of a targeted visitor to the marketer's page. A cost per view model, where a marketer pays for each unique visitor view of an advertisement or page. Or a cost per sale model, where a marketer pays based on each time a sale may be made. As will be appreciated, various ad campaigns and different methods may be used to determine an average conversion cost per customer.

As in block 530, a task may be obtained from a customer. For example, an online visitor may have clicked an ad for pest control services. The online visitor then may have been directed to the marketer's business page where the online visitor may have been presented with a number of available pest control tasks available to the online visitor to purchase. The online visitor may have purchased a premium spider eradication task, and may now be considered a customer.

As in block 540, a process may be used to calculate a task acquisition cost by using an average, mean, max, standard deviation or any other method to calculate a conversion cost per customer. As described above, an average conversion cost per customer may be calculated, this average may then be used to determine a task acquisition cost. In one example, the average conversion cost per customer may be $100 and a customer may purchase four tasks. Dividing the average conversion cost per customer by the four tasks purchased by the customer may result in a task acquisition cost of $25 per task. In another example, where the average conversion cost per customer may be $100, a customer may have purchased a single task, thus making the task acquisition cost equal to the average conversion cost per customer of $100. And in another example, a customer may have purchased a task that may be recurring, such as a weekly office cleaning task. Where the average conversion cost per customer may be $100, the recurring task acquisition cost may be equal to the average conversion cost per customer of $100, or a method may be used to divide the task acquisition cost over the expected lifetime of the recurring task. As can be appreciated, various methods exist in determining a task acquisition cost using the conversion cost per customer.

As in block 550, a task may be provided to a service provider at a fixed price determined or influenced by the task acquisition cost. The fixed price may be made available to the service provider through an electronic interface where the service provider may view the details associated with a task and the task's fixed price. The service provider may then select the one or more tasks that the service provider may want to purchase. For example, the service provider may be a mason and may desire to obtain masonry work in the service provider's geographical work area. The service provider may view available masonry tasks located in the service provider's area and purchase those tasks that fit the service provider's criteria at a fixed price.

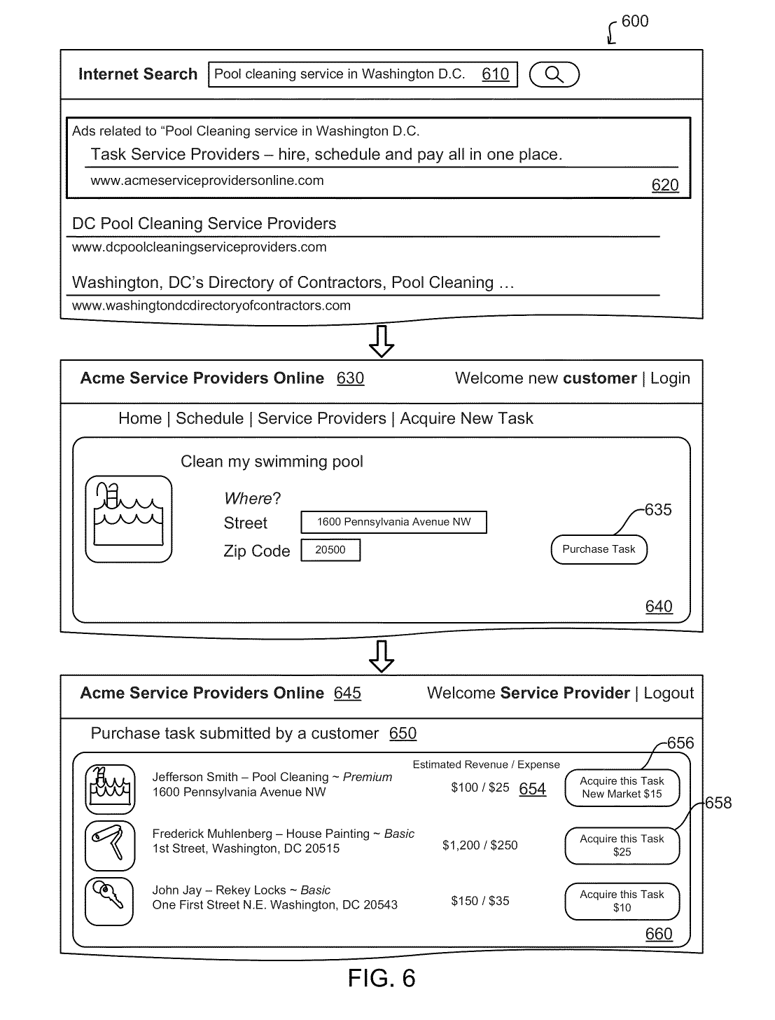

FIG. 6 depicts example pages 600 illustrating elements of a method for a service provider to acquire a task at a fixed price. An online ad campaign may be utilized to attract online visitors to a marketer's business page. An online visitor may use a search engine 610 to find service providers in the online visitor's area. The ad campaign may target online visitors that may be searching for a particular kind of service or service provider. When a search engine 610 returns results for a search, the results may include an ad 620 generated by the marketer's ad campaign. For example, where an online visitor that resides in the Washington D.C. area may be searching for a service provider to clean the online visitor's swimming pool, the online visitor may use a search engine to conduct a search for pool cleaning services in the Washington D.C. area. The search engine may return both links and ads to local service providers in the Washington D.C. area.

When an online visitor clicks on a marketer's ad, the online visitor may be directed to the marketer's business page 630. Ad campaign statistics may be gathered and stored to allow marketers to access the information in the future. Landing on the marketer's business page, an online visitor may be presented with a task 640 that may be performed by a service provider and that may match the online visitor's initial search. The online visitor may then decide to purchase the task 635, making the online visitor a customer. Continuing the example from above, the online visitor searching for pool cleaning service in Washington D.C. may click on the marketer's ad 620. The online visitor may then be taken to the marketer's business page 630 where the online visitor may purchase a swimming pool cleaning task. Marketing statistics relating to the online visitor's interaction with the ad campaign and resulting task purchases may be stored and used later to determine an average conversion cost per customer. The average conversion cost may be calculated based upon the amount expended to convert an online visitor into a customer.

A service provider may use an electronic interface, which may include a page 645 to view and/or purchase a task requested by a customer 650. The page may contain a list of available tasks 660 that a service provider may acquire. An available task may include an estimate 654 of predicted task revenues and task expenses should the service provider acquire the task. For example, a service provider may acquire a house painting task. Along with other task information, an estimate may be shown predicting that the service provider may expect to earn a total revenue of $1,200 and incur expenses of $250 should the service provider perform the task. The page 645 may allow a service provider to purchase a task 658 at a fixed price. A task's fixed price may be determined by calculating a task acquisition cost using the average conversion cost per customer. In other words, the cost associated with converting an online visitor into a paying customer may be used to come up with a task acquisition cost. This task acquisition cost with an optional markup may be passed on to a service provider in the form of a fixed cost.

Where there may be insufficient historical online marketing cost data to calculate a reliable average cost, a fixed price may be increased by an amount determined by a standard deviation of the task acquisition cost. For example, insufficient historical online marketing data may exist in a market that has recently been opened. Because of the lack of historical data, it may be difficult to calculate a fixed price that accurately reflects the amount expended to convert an online visitor into a task purchasing customer. In an effort to compensate for the lack of data, the fixed price 656 charged to a service provider may be increased for that new market. As additional historical online marketing cost data may be collected, the amount added to a fixed price may be continuously updated. Continuing from the previous example, as the new market matures and additional marketing data may be collected, the fixed price may be updated on a regular basis to better reflect the cost associated with converting online visitors to task purchasing customers in the new market. In addition to increasing the fixed price by an amount determined by a standard deviation, the fixed price may be increased by an additional amount determined by a margin of error. For example, where an average cost may be perfectly reliable, an increase to the fixed price may be desirable for variance in the tasks or work performed in order to avoid statistically possible losses over a short term period.

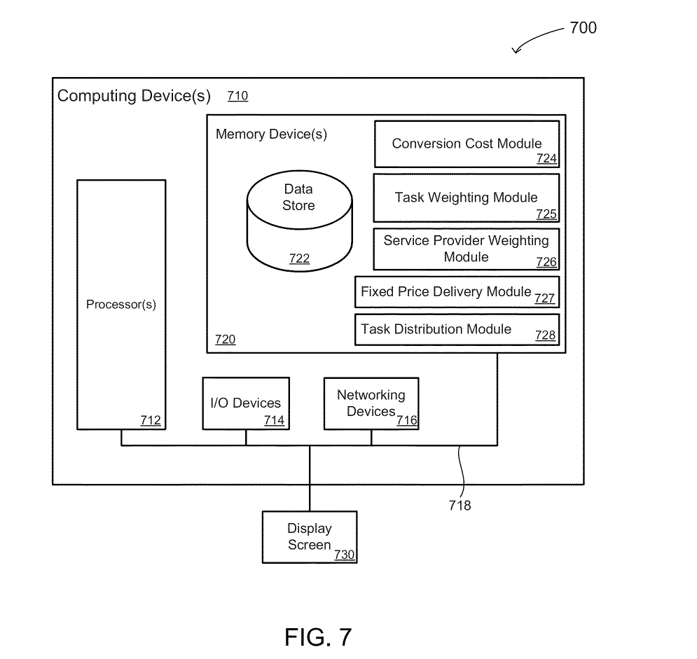

FIG. 7 illustrates a computing device 710 on which modules of this technology may execute. A computing device 710 is illustrated on which a high level example of the technology may be executed. The computing device 710 may include one or more processors 712 that are in communication with memory devices 720. The computing device 710 may include a local communication interface 718 for the components in the computing device. For example, the local communication interface may be a local data bus and/or any related address or control busses as may be desired.

The memory device 720 may contain modules that are executable by the processor(s) 712 and data for the modules. Located in the memory device 720 are modules executable by the processor(s) 712. For example, a conversion cost module 724, a task weighting module 725, a service provider weighting module 726, a fixed price delivery module 727, a task distribution module 728, and other modules may be located in the memory device 720. The modules may execute the functions described earlier. A data store 722 may also be located in the memory device 720 for storing data related to the modules and other applications along with an operating system that may be executable by the processor(s) 712.

Other applications may also be stored in the memory device 720 and may be executable by the processor(s) 712. Components or modules discussed in this description that may be implemented in the form of software using high programming level languages that are compiled, interpreted or executed using a hybrid of the methods.

The computing device may also have access to I/O (input/output) devices 714 that are usable by the computing devices. An example of an I/O device may be a display screen 730 that may be available to display output from the computing devices. Other known I/O device may be used with the computing device as desired. Networking devices 716 and similar communication devices may be included in the computing device. The networking devices 716 may be wired or wireless networking devices that connect to the internet, a LAN, WAN, or other computing network.

The components or modules that are shown as being stored in the memory device 720 may be executed by the processor(s) 712. The term “executable” may mean a program file that may be in a form that may be executed by a processor 712. For example, a program in a higher level language may be compiled into machine code in a format that may be loaded into a random access portion of the memory device 720 and executed by the processor 712, or source code may be loaded by another executable program and interpreted to generate instructions in a random access portion of the memory to be executed by a processor. The executable program may be stored in any portion or component of the memory device 720. For example, the memory device 720 may be random access memory (RAM), read only memory (ROM), flash memory, a solid state drive, memory card, a hard drive, optical disk, floppy disk, magnetic tape, or any other memory components.

The processor 712 may represent multiple processors and the memory 720 may represent multiple memory units that operate in parallel to the processing circuits. This may provide parallel processing channels for the processes and data in the system. The local interface 718 may be used as a network to facilitate communication between any of the multiple processors and multiple memories. The local interface 718 may use additional systems designed for coordinating communication such as load balancing, bulk data transfer and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. A method to distribute a plurality of tasks among a plurality of service providers, the method comprising:
under the control of a processor and memory configured with executable instructions,
obtaining a task purchase from a customer through an electronic interface having task details to be performed by a service provider;
weighting the task based upon the task details;
weighting a plurality of service providers available to perform the task based upon a plurality of service provider criteria; and
assigning the task to a service provider using a statistical method that considers the weighting placed upon the task and the weighting of the plurality of service providers.

2. The method as in claim 1, wherein weighting the task further comprises assigning a different weight to a task that is a recurring task as compared to a task that is not recurring.

3. The method as in claim 1, wherein weighting the task further comprises assigning a greater weight to a task that is a recurring task as compared to a task that is not recurring.

4. The method as in claim 1, wherein weighting the plurality of service providers further comprises assigning a greater weight to a service provider that has a closer proximity to a task location.

5. The method as in claim 1, wherein weighting the plurality of service providers further comprises assigning a greater weight to a service provider that has performed one or more tasks that are close in proximity to a task location.

6. The method as in claim 1, wherein weighting the task further comprises assigning a greater weight to a task located within a desirable market.

7. The method as in claim 1, wherein weighting the task further comprises weighting the task based upon a task type that is to be performed.

8. The method as in claim 1, wherein weighting the task further comprises weighting the task based upon a value of a task where the value of a task is determined by a task's details.

9. The method as in claim 1, wherein weighting the plurality of service providers further comprises assigning a greater weight to a service provider that makes more of a service provider's time slots available to a scheduling system.

10. The method as in claim 1, wherein weighting the plurality of service providers further comprises assigning a greater weight to a service provider with a plurality of time slots that the service provider made available to a scheduling system that are left unassigned.

11. The method as in claim 1, wherein weighting the plurality of service providers further comprises assigning a lesser weight to a service provider that has been assigned a greater number of tasks as compared to other service providers.

12. The method as in claim 1, wherein weighting the plurality of service providers further comprises weighting a service provider based on work quality.

13. The method as in claim 1, wherein weighting the plurality of service providers further comprises weighting a service provider based on service provider qualifications.

14. The method as in claim 1, wherein weighting the plurality of service providers further comprises assigning a greater weight to a service provider that has contributed a plurality of new customers to a customer referral system.

15. A method for a service provider to acquire a task at a fixed price, the method comprising:
under control of a processor and memory configured with executable instructions,
identifying historical online marketing cost data;
calculating an average conversion cost per customer based upon an average amount expended to convert an online visitor into a customer;
obtaining a task from the customer;
calculating a task acquisition cost using the average conversion cost per customer; and
providing a task to a service provider at a fixed price determined by the task acquisition cost.

16. The method as in claim 15, further comprising increasing the fixed price by an amount determined by a standard deviation of the task acquisition cost where insufficient historical online marketing cost data exists to ensure a reliable average cost.

17. The method as in claim 16, further comprising increasing the fixed price by an amount determined by a margin of error.

18. The method as in claim 16, further comprising continuously updating an amount that is added to the fixed price as additional historical online marketing cost data is collected.

19. The method as in claim 15, wherein identifying historical online marketing cost further comprises identifying a similar market for online marketing as compared to a current market and using the historical online marketing cost data of the similar market as a market proxy where insufficient data exists for the current market to calculate a fixed cost.

20. The method as in claim 15, further comprising providing a service provider an estimate of predicted task revenues and task expenses for the task acquired.

21. A system for a service provider to acquire a customer at a fixed price, the system comprising:
a data store to store historical online marketing cost data;
an average conversion cost module that uses historical online marketing cost data to calculate an average monetary amount expended to convert an online advertising prospect into a customer; and
a fixed price delivery module to deliver a task to a service provider at a fixed price.

22. A method to distribute a plurality of tasks among a plurality of service providers, the method comprising:
under the control of a processor and memory configured with executable instructions,
obtaining a task purchase from a customer through an electronic interface having task details to be performed by a service provider;
identifying a plurality of task criteria based upon the task details;
identifying a plurality of service providers available to perform the task based upon a plurality of service provider criteria; and
assigning a task to a service provider based upon the plurality of task criteria and the plurality of service provider criteria.

23. The method as in claim 22, wherein identifying the plurality of task criteria includes a criterion that a task is recurring.
